(19) United States
(12) Patent Application Publication
(10) Pub. No.: US 2007/0189944 A1
(43) Pub. Date: Aug. 16, 2007

(54) Porous microparticles with solid cores

(75) Inventors: Joseph J. Kirkland, Wilmington, DE (US); Timothy J. Langlois, Wilmington, DE (US)

Correspondence Address: HOFFMANN & BARON, LLP, 6900 JERICHO TURNPIKE, SYOSSET, NY, 11791, US

(73) Assignee: Advanced Materials Technology, Inc.

(21) Appl. No.: 11/705,629

(22) Filed: Feb. 13, 2007

Related U.S. Application Data
(60) Provisional application No. 60/772,634, filed on Feb. 13, 2006.

(51) Int. Cl. C01B 33/26; G01N 30/02; B01D 15/08

(52) U.S. Cl. 423/118.1; 422/70; 210/198.2

(57) ABSTRACT

The present invention relates to microparticles, particularly spherical silica microparticles, which may be useful in liquid chromatography. Specifically, the microparticles include a solid core and an outer porous shell surrounding and irreversibly joined to the core. The shell is composed of a plurality of colloidal nanoparticles, which are applied using an electrostatic multi-multilayering method. The resulting microparticles have a small particle diameter, such as about 1 μm to 3.5 μm, a high particle density, such as about 1.2 g/cc to 1.9 g/cc, and a high surface area, such as about 50 m²/g to 165 m²/g. These microparticles can be used to form packed beds and liquid chromatographic columns, which are more efficient and rugged than conventional liquid chromatographic columns.

### CROSS-REFERENCE TO RELATED APPLICATIONS

The present application claims the benefit of U.S. Provisional Application No. 60/772,634, filed Feb. 13, 2006, the contents of which are incorporated herein by reference.

### FIELD OF THE INVENTION

The present invention relates to microparticles, particularly spherical silica microparticles, which have a solid core and an outer porous shell surrounding and irreversibly joined to the core. The shell includes a plurality of colloidal nanoparticles, particularly alike colloidal solid silica nanoparticles. The present invention also relates to a packed bed of these microparticles for use in chromatography and a process for their manufacture using an electrostatic multi-multilayering method.

### BACKGROUND OF THE INVENTION

Particles consisting of cores with porous shells have many practical applications, such as, chemical or biochemical reactors, catalysts, chromatography packing materials and the like. Liquid chromatography is discussed herein as a specific illustration of the present invention, however, the invention is not limited to chromatographic uses.

In liquid chromatography, it is customary to pass a mixture of solute molecules, i.e., the components to be resolved, in a carrier fluid through a separative zone in a chromatographic apparatus. The separative zone includes a packed bed of particles having a sorptive stationary phase. This process allows different solute molecules to be separated from one another.

The chromatographic apparatus generally employed for separating mixtures of solutes are columns, particularly high performance liquid chromatography (HPLC) columns. These columns generally are open tubes that have been packed with a granular material. For analytical applications, the columns usually are of small internal diameter, whereas for preparative chromatography, larger diameter columns are typically employed. Support materials commonly employed for chromatography are granules having sorptively active surfaces or surfaces that have been coated with a substance that is sorptively active. Passing the mixture to be separated through the column results in repeated chemical interactions between the different components of the sample and the chromatographically-active surfaces. Different compounds migrate at different speeds through the column due to these repeated interactions. The separated components in the column effluent are generally passed through an analyzer or detector, for example, an ultraviolet absorption detector in liquid chromatography, to determine when the resolved components emerge from the column and to permit the identification and quantitative measurement of each component.

It has long been recognized that superior chromatographic supports for liquid chromatography would consist of a plurality of discrete particles of regular shape, preferably spheres, having surfaces with a large population of superficial, shallow pores and no deep pores. For different columns to provide reproducible results, the support granules should be regular in particle size and their surface characteristics controllable and reproducible.

For instance, silica particles with solid cores and a porous outer shell were described in U.S. Pat. No. 3,505,785 to Kirkland. The silica particles described in this patent are larger than 5 μm in diameter, particularly 5-500 μm in diameter. These particles are formed by layering monolayers of a silica sol successively onto a solid core by an electrostatic process involving alternating monolayers of a charged organic polymer and the silica sol. The particles in each monolayer are alike. The organic interlayer is then eliminated and the material sintered to produce a final mechanically stable superficially porous particle. These particles were commercially offered under the trade name “Zipax” from DuPont (Wilmington, Del.). The commercially available particles were about 30 μm in overall diameter with a 1 μm thick outer shell of 100 nm pores, resulting in a particle surface area of about 1 m²/g. The particles forming the porous shell were arranged in a random close-packed configuration.

Essentially identical particles using the monolayering process with alternating layers of oppositely charged nanoparticles and polyelectrolytes also were described in U.S. Pat. No. 6,479,146 to Caruso et al. The process described in this patent prepares coated particles and hollow shells by coating colloidal particles with alternating layers of oppositely charged nanoparticles and polyelectrolytes in a manner that is essentially identical to that described in U.S. Pat. No. 3,505,785. A similar approach also was described in U.S. Pat. No. 7,101,575 to Donath et al. According to the teachings of this patent, organic-based capsules of up to 10 μm are prepared using a plurality of oppositely charged polyelectrolyte layers.

Superficially porous silica particles were described by Kirkland et al. in “Superficially Porous Silica Microspheres for Fast High-Performance Liquid Chromatography of Macromolecules,” J. Chromatogr. A, 890 (2000) 3-13. As described therein, the particles were prepared by layering monolayers of a silica sol in the same manner as described in U.S. Pat. No. 3,505,785 above, or alternatively, by a process whereby a urea-formaldehyde/silica sol coacervate film was cast onto a solid silica core. The organic polymer then was eliminated and the particles sintered to increase strength and eliminate unwanted micropores. The microparticles forming the final porous structure were arranged in a random close-packed configuration. The particles prepared had a diameter of 3.8 to 6.2 μm with pore sizes of 9 to 80 nm, porous shell thicknesses of 0.25 to 1.0 μm and surface areas of 3.0 to 21 m²/g. One form of these particles was commercially offered under the tradename “Poroshell” by Agilent Technologies (Wilmington, Del.), as discussed by Kirkland in “Ultrafast Reversed-Phase High-Performance Liquid Chromatographic Separations: An Overview,” J. Chromatogr. Sci. 38 (2000) 535-544. The commercially available particles had a diameter of 5 μm with a 0.25 μm thick outer shell of 30 nm pores and a surface area of 5 m²/g.

A process for preparing superficially porous macroparticles having a particle diameter of about 5 to 500 μm was described in U.S. Pat. No. 4,477,492 to Bergna and Kirkland. These particles were prepared by spray drying a silica sol onto a solid silica core. This spray-drying process produced a porous outer layer of colloidal silica particles that was arranged in a regular close-packed structure as compared to the random close-packed porous structure of the superficially porous particles described above. U.S. Pat. No. 3,485,658 to Iler describes articles including a solid-state substrate having a porous coating of at least three monolayers of solid colloidal particles on its surface. The particles in each monolayer are alike, however, initially differ from each adjacent monolayer.

Another commercially offered silica particle for use in chromatography was sold under the trade name “Corasil” in the early 1970's by Waters Associates (Milford Mass.). The particles included a solid spherical silica core that was covered with an active porous silica outer layer. These 25-μm diameter particles were specifically designed for liquid-solid or adsorption chromatography with a surface area of about 25 m²/g. The pore structure of these particles was not defined.

Although silica particles for use in chromatography have been prepared by the processes described above, these particles exhibit a number of disadvantages for certain applications. Specifically, such conventional particles typically have diameters of 3.8 μm or greater with relatively wide particle size distributions. The wide particle size distributions associated with such particles has required particle sizing by methods such as air classification or liquid elutriation. This particle diameter range and the wide particle size distributions resulted in HPLC performance that was less than optimum. In addition, traditional silica particles have been prepared by monolayering or coacervation techniques, as described above, to produce random close-packed structures. The techniques used involved the laying down of one layer at a time of one particle thickness. Such technique is detrimental to manufacturing efficiency as the coating process must be repeated as many times as necessary to build up a chromatographically functioning layer of particles. Alternatively, regular close-packed outer porous structures have been produced by spray drying or ill-defined outer structures have been formed by simple mechanical deposition of irregular silica microparticles. Such surfaces often are not physically homogenous and are not configured for optimum chromatographic use.

There is a need for superficially porous particles that have a diameter smaller than 3.8 μm and have a narrower and more uniform particle size distribution. In addition to uniform particle size distribution, there is a need for particles having a greater density and surface area, as well as a random pore structure and broader pore size distribution. It would be desirable to provide such particles that can be formed into packed beds that are more chromatographically-efficient and rugged than those formed with conventional particles.

### SUMMARY OF THE INVENTION

The present invention provides microparticles, such as spherical silica microparticles, having an overall diameter of about 1 to 3.5 μm, which have an extremely narrow and uniform size distribution because of the method of synthesis. Specifically, these particles have a particle size distribution less than ±15% (one sigma) of the volume average diameter. As a result of the unusually narrow particle size distribution and the higher particle density due to the solid cores, these microparticles can be formed into packed beds that are significantly more chromatographically-efficient than other materials available for this use. The unusual characteristics of the microparticles also allow these materials to be formed into packed beds that are not only highly efficient, but also are highly rugged, even when repeatedly used at high column pressures and high liquid phase velocities.

More specifically, in some embodiments, there is provided a microparticle including: a solid core; and an outer porous shell surrounding the core, the shell including a plurality of colloidal inorganic nanoparticles, where the microparticle has a diameter of about 1 μm to about 3.5 μm, a density of about 1.2 g/cc to about 1.9 g/cc and a surface area of about 50 m²/g to about 165 m²/g.

In some other embodiments, there is provided a spherical silica microparticle including: a solid silica core; and an outer porous shell surrounding the core, the shell including a plurality of colloidal silica nanoparticles, where the microparticle has a diameter of about 1 μm to about 3.5 μm, a density of about 1.2 g/cc to about 1.9 g/cc and a surface area of about 50 m²/g to about 165 m²/g.

In yet other embodiments, there is provided a packed bed for liquid chromatography including: a plurality of microparticles including a solid core and an outer porous shell surrounding the core, the shell including a plurality of colloidal inorganic nanoparticles, where the microparticles have an average diameter of about 1 μm to about 3.5 μm, an average density of about 1.2 g/cc to about 1.9 g/cc and an average surface area of about 50 m²/g to about 165 m²/g, and where the packed bed has a reduced plate height of less than about 2 at the plate height minimum under optimum operating conditions.

In still other embodiments, there is provided an apparatus for liquid chromatographic separations including: a region through which materials to be separated are passed; and a packed bed including a plurality of microparticles contained in the region, the microparticles including a solid core and an outer porous shell surrounding the core, the shell including a plurality of colloidal inorganic nanoparticles, where the microparticles have an average diameter of about 1 μm to about 3.5 μm, an average density of about 1.2 g/cc to about 1.9 g/cc and an average surface area of about 50 m²/g to about 165 m²/g, and where the packed bed has a reduced plate height of less than about 2 at the plate height minimum under optimum operating conditions.

### BRIEF DESCRIPTION OF THE DRAWINGS

FIG. 1 is a representation of a partially cut-away cross-section of a spherical microparticle in accordance with the present invention.

FIG. 2 is an electron micrograph image of a cross-section of a spherical microparticle in accordance with the present invention.

FIG. 3 is a schematic diagram of a process for preparing a microparticle in accordance with the present invention.

FIG. 4 shows the extremely narrow particle size distribution of the microparticles in accordance with the present invention. The diagram shows the particle size distribution of 2,324 microparticles at 2.65 μm average particle diameter.

FIG. 5 shows column back pressure versus mobile phase velocity data obtained with liquid chromatographic columns packed with microparticles in accordance with the present invention having a 2.7-μm particle diameter as compared to totally porous particles having a 1.7-μm particle diameter and totally porous particles having a 3.5-μm particle diameter.

FIG. 6 shows plate height (also referred to as HETP, or height equivalent to a theoretical plate) versus mobile phase velocity data obtained with liquid chromatographic columns packed with microparticles in accordance with the present invention having a 2.7-μm particle diameter as compared to totally porous particles having 5-μm, 3.5-μm and 1.8-μm particle diameters. The plots demonstrate the superior efficiency of the microparticles of the present invention for liquid chromatographic separations.

FIG. 7 is a chromatogram of a liquid chromatographic separation of uracil, phenol, 4-chloro-1-nitrobenzene and naphthalene, which demonstrates the ruggedness and stability of a liquid chromatographic column packed with microparticles in accordance with the present invention.

### DETAILED DESCRIPTION OF THE INVENTION

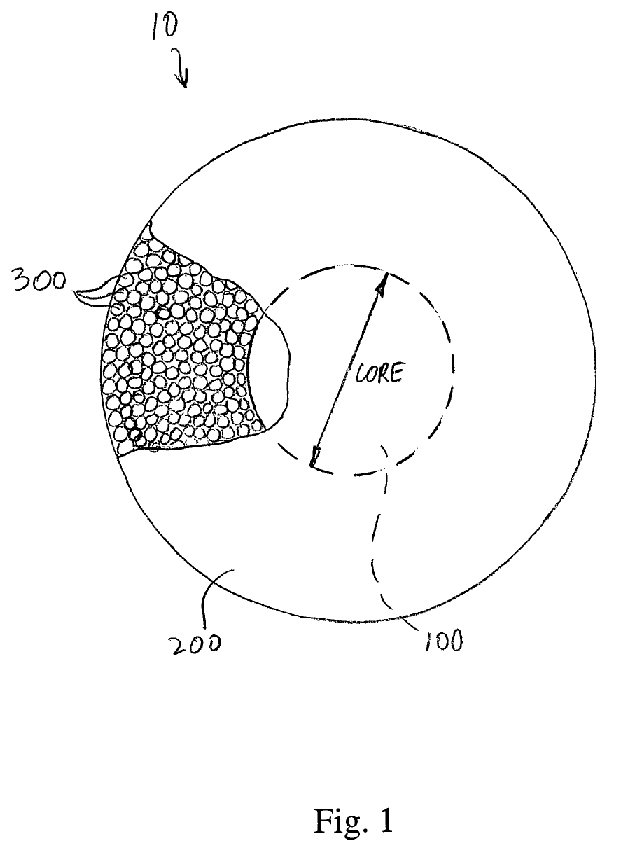

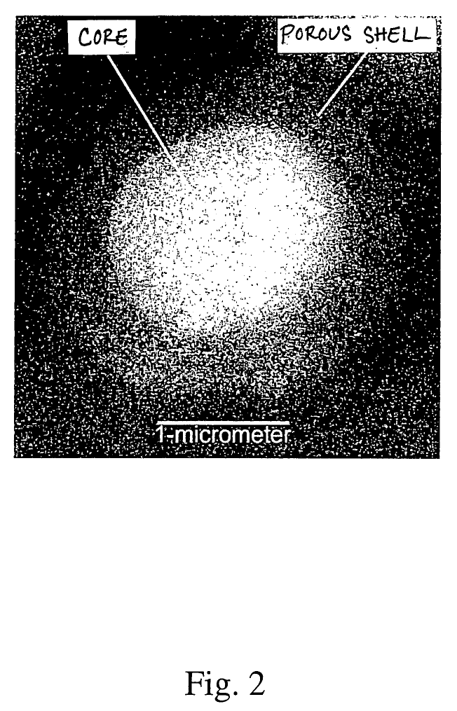

The present invention relates, but is not limited, to microparticles for use in chromatographic separations and a process for preparing such microparticles. In some embodiments, the present invention is directed to spherical microparticles, particularly spherical silica microparticles. The microparticles are superficially porous and are sometimes referred to as “shell particles”. As shown in FIG. 1, the microparticle 10 generally includes a core 100, which may be solid, and an outer porous shell, or crust, 200 surrounding and irreversibly joined to the core 100. The outer shell 200 includes a plurality of colloidal nanoparticles 300. The core and outer porous shell also can be seen in the micrograph of FIG. 2, which shows the cross-section of a microparticle as described herein. In some embodiments, the colloidal nanoparticles are colloidal inorganic, particularly silica, nanoparticles. In addition, the colloidal nanoparticles are in a randomly packed configuration.

As used herein, the term “solid” refers to a core that is in a solid state as distinguished from a liquid or gas.

As used herein, the term “impervious” refers to a material having a surface sufficiently free from pores so that when employed as the substrate in a chromatographic process, the materials passing through a zone of these particles will not enter the interior of the core. This does not require the material to be solid and impenetrable, but rather a material that will be undamaged by the process described herein for preparing the microparticle.

As used herein, the term “colloidal nanoparticle” refers to inorganic nanoparticles or organic nanoparticles or a mixture thereof. The suspension of colloidal nanoparticles in a fluid, particularly water, is referred to herein as a “suspension”.

As used herein, the term “suspension” refers to any slurry, suspension or emulsion of nanoparticles of any shape or size in a fluid. The suspension may refer to a system that is unstable with respect to settling over time but is dispersed for the period of use in some embodiments described herein.

As used herein, the term “polyelectrolyte” refers to a charged organic colloid or charged macromolecule that is soluble or suspendable in the fluid.

As used herein, the term “nanoparticle” generally refers to particles with a largest dimension (e.g., a diameter) of less than or equal to about 500 nm (nanometers), particularly about 4 nm to about 500 nm.

As used herein, the term “monolayer” refers to a layer that is one particle thick, the layer thus being made up of substantially contiguous particles in a single plane. In contrast, the term “multilayer” refers to a multiplicity of layers. A multilayer is thus greater than one particle thick and made up of a plurality of particles in more than one plane.

Due to the process of preparing the microparticles, which will be described in detail below, the resulting particles have a smaller particle diameter, as well as a greater density and surface area than conventional particles. Specifically, the microparticles described herein desirably have a diameter of about 1 μm to about 3.5 μm. The particles have a density of about 1.2 g/cc to about 1.9 g/cc, more specifically about 1.3 g/cc to about 1.6 g/cc, and a surface area of about 50 m²/g to about 165 m²/g. Additionally, the outer porous shells formed from the nanoparticles have an average pore size of 4 nm to 175 nm resulting from the randomly-packed nanoparticle configuration. The porous shell has thicknesses of 0.1 μm to 0.75 μm. As mentioned above, the microparticles have an extremely narrow and uniform size distribution, which is less than ±15% (one sigma) of the volume average diameter, more specifically less than ±10% (one sigma) of the volume average diameter, and even more specifically about ±5% (one sigma) of the volume average diameter in some embodiments.

The porous outer shell of the microparticles desirably is formed using colloidal nanoparticles in a manner to produce a largely random pore structure with a relatively broad pore size distribution. In particular, the pore size distribution of the outer porous shell is about 40% to about 50% (one sigma) of the average pore size with a porosity of about 55% to about 65% by volume of the outer porous shell. The porosity is about 25% to about 90% by volume of the total microparticle. This process involves the multi-multilayering of these colloidal nanoparticles by exposing a polyelectrolyte-coated surface to a fluid dispersion including the charged nanoparticles. The polyelectrolyte has an opposite surface charge to the charged nanoparticles and a molecular weight at the ionic strength of the fluid that is effective so that the first, second and subsequent layers include a multiplicity of nanoparticle layers that are thicker than monolayers. The resulting pore structure after removing the polyelectrolyte is random with a relatively wide pore size distribution, as mentioned above.

In addition, the present invention provides a packed bed of these microparticles that exhibits at the plate height minimum a reduced plate height, h, of <2, typically about 1.5 for small molecules at optimum operating conditions. The reduced plate, h, is the plate height, H, divided by the particle diameter as described in Chapter 2 of “Practical Method Development, 2^{nd} ed.”, L. R. Snyder, J. J. Kirkland, J. L. Glajch, John Wiley and Sons, New York, N.Y., 1997. In general, the lower the reduced plate height, h, the more efficient the packed bed or column. Reduced plate heights of about 2.5 to 3 customarily have been associated with very efficient packed columns for liquid chromatography. Accordingly, a reduced plate height of <2 evidences that the microparticles described herein can be used to produce extremely efficient packed beds and columns, as described in more detail below.

### Cores

In some embodiments described herein, the core of the microparticle is in the solid state. As mentioned above, “solid” means that the core is a solid as distinguished from a liquid or gas. In some embodiments, the core is impervious, as defined above. The core may be described as both solid and impervious in some embodiments. The core may have any shape that is suitable for use in chromatography, such as, but not limited to, rings, polyhedra, saddles, platelets, fibers, hollow tubes, rods and cylinder. Spheres are particularly suitable for chromatographic use herein due to their regular and reproducible packing characteristics and ease and convenience of handling.

The composition of the core is not critical except that it should be stable to the conditions employed to prepare the coating. In addition, the core should be capable of acquiring an electrical charge in the presence of a dispersion medium as this provides the attractive force enabling it to adsorb a first layer of the coating material. Many water wettable inorganic substances, such as silica, have negatively charged surfaces.

The cores may be, for example, glasses, sands, metals, metalloids, ceramics or silica-based materials. A particularly suitable material for use as the core is highly purified silica. Highly purified silica may be desirable due to its uniformity of surface characteristics and predictability of packing.

The core also may be “hybrid”, which includes inorganic-based structures in which an organic functionality is integral to both the internal or “skeletal” inorganic structure as well as the hybrid material surface. The inorganic portion of the hybrid material may be, for example, alumina, silica, titanium or zirconium oxides, or ceramic material. Silica is particularly desirable. Exemplary hybrid materials are shown in U.S. Pat. No. 4,017,528 and U.S. Pat. No. 6,528,167, the contents of which are incorporated herein by reference in their entirety. For example, in one embodiment in which the inorganic portion is silica, “hybrid silica” refers to a material having the formula SiO₂/(R¹ₚR²_{q} SiOₜ)ₙ or SiO₂/[R³(R¹ᵣSiOₜ)ₘ]ₙ; wherein R¹ and R² are independently a substituted or unsubstituted C₁ to C₇ alkyl group, or a substituted or unsubstituted aryl group, R³ is a substituted or unsubstituted C₁ to C₇ alkylene, alkenylene, alkynylene, or arylene group bridging two or more silicon atoms, p and q are 0, 1, or 2, provided that p+q=1 or 2, and that when p+q=1, t=1.5, and when p+q=2, t=1; r is 0 or 1, provided that when r=0, t=1.5, and when r=1, t=1; m is an integer greater than or equal to 2; and n is a number from 0.01 to 100.

The core has an average diameter in the range of about 0.5 μm to about 3.25 μm with a very narrow particle size distribution. In some embodiments, the core has a diameter of about 1 μm to about 3.0 μm. A variety of methods may be used to produce such cores. For example, for highly purified silica, cores can be obtained by careful liquid elutriation fractionation of the smallest-available glass beads, which may be obtained from, for example, Potters Industries Inc. (Valley Forge, Pa.). These glass beads are not highly purified and contain various elements that might be deleterious for certain uses such as HPLC. Therefore, these beads may be surface-purified by exhaustive treatment with hydrochloric and nitric acid to remove contaminating materials. This acid treatment also ensures that the silica core surface is highly hydroxylated, which may be important for subsequent coating operations.

Another method for obtaining cores for use herein is to densify totally porous silica microspheres of the proper size to solid particles. One useful method of densification is to carefully sinter the particles at a high temperature, but this also may be accomplished by autoclaving. Depending on the size and purity of the silica, the sintering temperature could be as high as 1100° C. or more. Totally porous silica microspheres of the desired size can be produced in several ways, for example by the methods described in U.S. Pat. No. 3,782,075 to Kirkland and U.S. Pat. No. 4,874,518 to Kirkland et al., the contents of which are incorporated by reference herein. Porous silica microspheres also may be produced by other methods, such as described in K. K. Unger, Porous Silica, Elsevier, Amsterdam (1979). The size of these totally porous particles should be chosen to take into account the loss in particle diameter when the particle is densified to a solid core from the original totally porous structure. For example, particles made by the process of U.S. Pat. No. 4,874,518 will shrink about 20% when totally densified. Accordingly, if a solid core of 2.0 μm is desired, the totally porous particle of U.S. Pat. No. 4,874,518 should be about 2.5 μm in diameter. The surface of particles densified in this manner may be rehydroxylated to allow the subsequent coating of a porous shell by the method described herein. Typically, this rehydroxylation can take place by boiling in strong hydrochloric or nitric acid or by the procedures described in J. Kohler and J. J. Kirkland, J. Chromatogr. 385 (1987) 125.

Still another method for preparing the cores for use herein is to use the method described in U.S. Pat. No. 4,775,520 to Unger et al., the contents of which are incorporated by reference herein. In accordance with this method, small seed particles of highly purified silica sol nanoparticles are first prepared by a method such as described by Stober et al., J. Colloid Interface Sci. 26 (1968) 62-69. Typically, these silica sol seed particles should be larger than 250 nm and preferably larger than 500 nm. These seed silica sol particles are then grown into the cores of the desired size by depositing silica produced by the slow hydrolysis of tetraethyl-o-silicate by dilute ammonia while the seed particles are in suspension. The final particles contain some micropores, and thereby, if needed, can be totally densified by a method such as autoclaving or sintering. Again, if sintering is used for densification, in some embodiments the final solid cores may be rehydroxylated by methods such as those described above.

### Porous Shell

The outer porous shell of the microparticle includes a plurality of colloidal nanoparticles. In particular, the porous shell includes layers of colloidal nanoparticles. These layers are applied to the core as multilayers, which, as defined above, are thicker than simple monolayers. The nanoparticles may be inorganic or organic or a mixture of both. Desirably, the nanoparticles are inorganic. The colloidal nanoparticles may be irreversibly bound to the core, for example, by sintering or by autoclaving. Specifically, the nanoparticles may be irreversibly joined to the core by the process of preparation described herein. These nanoparticles form the outer porous shell having a thickness of about 0.1 μm to about 0.75 μm and a shell volume of about 25% to about 90% by volume of the microparticle.

The colloidal nanoparticles that make up the porous shell may be alike nanoparticles. The alikeness of the nanoparticles refers mainly to their physical characteristics, such as size, shape, density and surface charge, but the nanoparticles also may be alike in chemical composition. In some embodiments, this size and shape may be substantially uniform spheres.

There is no general limitation as to the nature of the composition of these colloidal nanoparticles, except for their suitability for use in chromatography. Choice of composition is based on the eventual application and, for example, the nature of the chromatographically active substance, which may be used with the particles or coated on their surfaces, and the substances that will be chromatographically separated with respect to chemical type, size of molecules, and the like. The nanoparticles may be any substance that can be reduced to a colloidal state of subdivision in which the nanoparticles have surfaces bearing ionic charges. The nanoparticles are dispersible in a medium as a colloidal dispersion. Water is a useful medium for dispersions of nanoparticles bearing ionic charges. Examples of aqueous dispersions of colloidal nanoparticles, sometimes called sols, include, without limitation, dispersions of colloidal amorphous silica, iron oxide, alumina, thoria, titania, zirconia and aluminosilicates including colloidal clays, such as montmorillonite, colloidal kaolin, attapulgite and hectorite.

In some particularly desirable embodiments, the nanoparticles are colloidal silica nanoparticles. These silica nanoparticles may be solid. Silica is desirable due to its low order of chemical activity, ready dispersability and easy availability of aqueous sols of various concentrations.

The colloidal nanoparticles also may include organic materials and biological materials, such as proteins, enzymes, antibodies, DNA or RNA as a suspension or solution in the fluid.

The particle sizes of the colloidal nanoparticles are generally in the range of about 4 nm to about 500 nm. In particular, as used herein “nanoparticle” refers to particles with a largest dimension (e.g., a diameter) of less than or equal to about 500 nm (nanometers). All ranges of particles sizes between about 4 nm and about 500 nm are included herein. However, in some embodiments, it also is possible that nanoparticles having a slightly larger diameter could be employed. In some embodiments, the nanoparticles may have a particle size distribution within the ranges from about 4 nm to about 500 nm, more specifically about 4 nm to about 200 nm, and even more specifically about 6 nm to about 150 nm.

It will be appreciated by those skilled in the art that various processes and techniques may be used to prepare the outer porous shell on the core of the microparticle. By way of non-limiting example, in some embodiments, the process for preparing the outer porous shell on the solid cores involves a multi-multilayering method, which is described in commonly assigned U.S. Provisional Application No. 60/772,634, filed Feb. 13, 2006, the benefit of which is claimed herein, and also described in commonly assigned U.S. patent application entitled “Substrates with Porous Surface” and filed on Feb. 13, 2007 (Express Mail Label No. EV 974903679 US; Attorney Docket No. 1644-6), the contents both of which are incorporated herein by reference in their entirety. It also is contemplated in the present invention that other processes of preparing superficially porous particles may be modified to prepare the microparticles described herein.

In accordance with the preferred process of preparing the microparticles, coating of layers of nanoparticles, such as silica sols, is accomplished by contacting a surface, such as the charged solid core particles described herein, with a colloidal dispersion or solution of an organic polyelectrolyte material that has an opposite charge. These polyelectrolyte molecules will be attracted to and bound to the oppositely-charged surface of the solid cores. This then forms a surface of opposite charge to that of the starting solid core. The reason for this is that once the polyelectrolyte binds to the solid core, the initial surface charges are neutralized so that the coated surface area no longer appears oppositely charged to the polyelectrolyte molecules remaining in the dispersion. The surface will then assume the excess charge of the polyelectrolyte. If the polyelectrolyte has a sufficiently high molecular weight and is in an extended form, then the surface charge attributable to the polyelectrolyte will extend beyond the immediate vicinity of the original solid core and the bound layer of polyelectrolyte. For instance, in some embodiments, the polyelectrolyte has a weight average molecular weight (M_{w}) of about 100 kiloDaltons (kD) or greater, specifically about 250 kD or greater, more specifically about 350 kD or greater and even more specifically about 500 kD or greater. However, lower molecular weight polyelectrolytes may be employed in some embodiments.

The core with the bound polyelectrolyte is not dried down to a state where the organic layer is held close to the surface of the core particle. Rather, the electrostatically bound layer of polyelectrolyte should be maintained in a solvated condition so that the polyelectrolyte molecules extend out from the surface of the core particles. The extension of charge away from the surface allows the bound polyelectrolyte to achieve a higher capacity for attaching subsequent multilayers of oppositely charged nanoparticles than if the charges were restricted to the immediate vicinity of the surface.

Once the polyelectrolyte is bound to the surface, no further polyelectrolyte will be attracted and there will be no further build-up of polyelectrolyte. Excess polyelectrolyte is then removed by rinsing, and the altered core or microparticle is then immersed in a dispersion of colloidal nanoparticles, such as a virgin silica sol, whose surface charge is opposite from that of the organic polyelectrolyte-modified surface. Repeating the process by alternating immersions between the polyelectrolyte and the colloidal nanoparticles results in the formation of further multilayers in sequence. The combination of sufficiently high molecular weight of polyelectrolyte and sufficiently low ionic strength, typically less than 0.05 M of salt, more specifically less than 0.02 M of salt, in the reaction solution ensures that the layer of nanoparticles bound to the polyelectrolyte is not merely a monolayer but that multiple layers of nanoparticles are bound in each layering step. More specifically, as set forth above, “monolayer” refers to a layer that is one particle thick, the layer thus being made up of substantially contiguous particles in a single plane. A “multilayer” is made up of multiple layers, and thus, is thicker than a single monolayer and greater than one particle thick.

A number of the layers of the particles altered in this manner will consist of the organic polyelectrolyte molecules. After a sequential coating of the desired number of layers of nanoparticles (silica sol in the case of all-silica particles) is built up, the organic polyelectrolyte interlayers can be removed. This is accomplished by heating or extracting with a solvent, leaving a series of layers of like nanoparticles forming a porous layer or shell on the surface of the starting solid cores. This porous layer is formed by nanoparticles that are arranged in a random open, not close-packed, structure. Definitions of porous silica structures are provided in Ralph K. Iler, “The Chemistry of Silica” (1979) 481. As described therein, a random open structure means that the void space in the shell is about 55% to about 65% by volume. In contrast, a random close-packed structure means the void space in the shell is about 40% to about 50% by volume. A regular close-packed structure means the void space in the shell is about 25% to about 35% by volume. In general, the tighter the coating particles are packed, the less volume, or void space, the shell will have. Thus, a regular close-packed structure exhibits the tightest packing of these types of structures. Such tight packing, however, also leads to a smaller pore size distribution as the voids become much more uniform, especially if the coating particles are uniform in size and shape. The porous outer shell of the present invention has a random open structure and a wide pore size distribution.

To strengthen this porous shell and attach it firmly to the solid core, the particles then can be sintered at a high temperature or autoclaved. If sintering is used, the final particle may be rehydroxylated for possible subsequent reactions.

The porous shell on the solid cores prepared in this manner has a thickness of about 0.1 μm to about 0.75 μm for many applications, especially HPLC. This thickness range allows the rapid access of molecules to the internal pore surfaces, as molecules have a much shorter distance for diffusion, relative to totally porous particles. Molecules can rapidly move in and out of the thin porous shell. Therefore, the microparticles described herein allow rapid molecule mass transfer because of the fast kinetics of the thin outer shell. This rapid mass transfer is especially important when separating larger molecules, which show slower diffusion.

Average pore diameters in the range of about 4 nm to about 175 nm, more specifically about 6 nm to about 150 nm, produce the desired structure which has a (nitrogen) surface area of about 50 m²/g to about 165 m²/g. Some embodiments have a surface area of about 75 m²/g to about 150 m²/g. Smaller nanoparticles making up the porous shell produces the smaller pores and higher surface areas. Conversely, larger nanoparticles result in larger pores and lower surface areas. Particles with surface areas in the 50 m²/g to 165 m²/g range provide the basis for superior applications for many purposes because of the ability to allow desired interaction with a relatively large amount (mass) of molecules. In HPLC, this range of surface area permits the use of relatively large amounts of sample for separation without the so-called “sample overloading problem”, which results in non-linear adsorption or partition isotherms and poor chromatographic properties. The ability to use relatively large sample sizes also permits the higher detectability of low-concentration or trace components in a mixture.

### Organic Interlavers

As previously discussed, the process of preparing the microparticle includes the insertion of alternate multilayers of colloidal organic particles or organic polyelectrolyte molecules of opposite charge between the layers of colloidal nanoparticles as an important part of the sequential coating process. The interpolated layers provide the fresh, oppositely charged surfaces needed for the attraction and holding of the colloidal nanoparticles.

The composition of the organic polyelectrolyte interlayers is not critical, however, the average molecular weight (weight average, M_{w}) has been shown to have an effect on the number of layers of nanoparticles that are laid down per coating/wash cycle. Organic interlayers, for example, negatively or positively charged water-soluble gums, natural lattices, artificial lattices, proteins, synthetic polymers, and synthetic condensation products may be employed if suitably dispersible. The M_{w} of the desired organic interlayer is sufficient to provide a surface to which inorganic nanoparticles can bind in a layer thickness that is greater than one monolayer. To ensure this layer thickness, the organic interlayer should not be dried down during the coating process, as drying will tend to drive the polyelectrolyte to the core surface, rather than leave it to extend from the surface so that it can bind multiple nanoparticles per layer. The thickness of the coating layer will also depend on the ionic strength of the medium and in some embodiments, no additional salt is added to the medium. However, for purposes of control of the process, salt may be added as needed to produce the desired layer thickness.

Without wishing to be constrained by mechanism, it is believed that the thickness of each coating cycle is affected by ionic strength as a result of the shielding of charges along the chain of the polyelectrolyte by ions in solution. The end to end distance of the chain, and hence the area of chain exposed to nanoparticles, is governed by the Debye length of the system, which is a function of ionic strength. A detailed discussion of this phenomenon appears, for example, in “The Theory of Polyelectrolyte Solutions” by J-L. Barrat and J-F. Joanny, Advances in Chemical Physics 54 (1996) 1 and in X. Chatelier and J-F. Joanny, J. Phys II (France) 6 (1996) 1669-1686. One skilled in the art would be able to determine the optimum conditions of M_{w} of the polyelectrolyte and ionic strength of the solution for a required application.

As mentioned above, typical values of M_{w} suitable for the polyelectrolyte are about 100 kiloDaltons (kD) or greater, specifically about 250 kD or greater, more specifically about 350 kD or greater and even more specifically about 500 kD or greater.

Specific materials will be chosen with respect to the nature of the inorganic coating to provide the necessary opposite charge. Examples of suitable polyelectrolyte materials include, without limitation, poly(diethylaminoethylmethacrylate) acetate (poly-DEAM) or poly-p-methacrylyloxyethyldiethylmethyl ammonium methyl sulfate (poly-p-MEMAMS), poly(diallyldimethylammonium) chloride (PDADMA), and polymethacrylic acid.

### Depositing the Coating

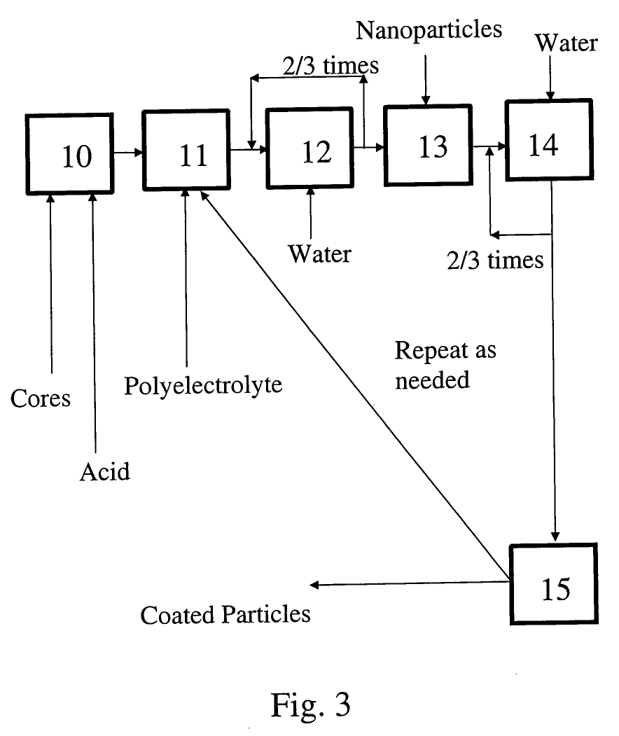

In accordance with some embodiments, FIG. 3 depicts a schematic diagram of a process for preparing the microparticles described herein. As shown in FIG. 3 the cleaned surface or particulate cores are immersed in a fluid dispersion and optionally brought to a pH of less than approximately 7 with acid in an acidification step 10. Any suitable acid can be employed and nitric acid is particularly desirable. The first coating may be the organic (polyelectrolyte) or the charged nanoparticles depending on the electrical charges of the colloids. Usually the polyelectrolyte will be first applied as a binder or interlayer between the core surface and the coating nanoparticles, as shown in step 11 in FIG. 3. After depositing a monolayer of the polyelectrolyte, the surface is rinsed 12 with a liquid that will rinse off any excess polyelectrolyte not directly bound to the surface. Water is commonly employed as a fluid, and the rinse is carried out as many times as necessary to clean the composition of excess polyelectrolyte. Two to three rinse cycles are typical as shown in FIG. 3. The treated, rinsed surface is then immersed in a dispersion of the coating nanoparticles 13, which are to form the permanent coating. The pH of the dispersion is typically less than 7, and desirably approximately 2.0-6.0.

The double-coated surface is now rinsed again 14 and optionally filtered or centrifuged to harvest the treated surface 15 from the fluids. The process of deposition of polyelectrolyte and colloidal nanoparticles through sequential processing is repeated until the desired number of multilayers of nanoparticles are put down on the surface. When the desired thickness has been built up, the nanoparticle coatings may be made permanent, such as by heating. Heating may be done at a high enough temperature so as to decompose, volatilize, or oxidize the organic interlayer, or alternatively, the particles may be dried and the organic interlayer removed by chemical means such as by oxidation or solvent extraction. However, for most chromatographic applications, the organic (polyelectrolyte) interlayers would be substantially removed by volatilization, which usually will involve thermal decomposition or oxidation.

The foregoing provides a description of a process for depositing the colloidal nanoparticle coating to prepare the microparticles described herein. It will be understood by one skilled in the art, however, that minor variations are possible and these are intended to be covered herein.

### Microparticle Product

The final microparticles desirably have average particle diameters of about 1 μm to about 3.5 μm, more specifically about 1.5 μm to about 3 μm in some embodiments. Beds of particles in this size range allow highly efficient interaction of molecules with the particle surface with modest resistance to carrier flow, which is usually a liquid. Thus, in BPLC, particle diameters in this range can be used in chromatographic columns to obtain very highly efficient separations using commercially available apparatus. Some HPLC apparatus can be operated to column back pressures of up to 1000 bar. In the 1 μm to 3.5 μm particle diameter size range, very rapid HPLC separations can be performed for high sample throughput in situations, for example, in which many samples must be analyzed in a short time period.

For some applications, such as for uses in HPLC, the surface of the porous shell may be modified. When the porous shell is composed of silica, the modification can take several forms. The silanol groups formed on the surface by rehydroxylation may be reacted with silanes to form a “bonded phase” in the manner described in Chapter 5 of “Practical HPLC Method Development”, L. R. Snyder, J. J. Kirkland, J. L. Glajch, John Wiley and Sons, New York, N.Y., 1997. These silanes can take different forms and contain different functional groups, depending on need.

For instance, a “bonded phase” may be formed onto the nanoparticle coating or the solid cores by adding functional groups to their surfaces. Examples of a process for the formation of bonded phases can be found in, for example, Lork, K. D., et. al., J. Chromatogr., 352 (1986) 199-211. For example, the surface of silica contains silanol groups, which can be reacted with a reactive organosilane to form a “bonded phase.” Bonding involves the reaction of silanol groups at the surface of the silica particles with, for example, halo or alkoxy substituted silanes, thus producing a Si—O—Si—C linkage.

Silanes for producing bonded silica include, without limitation, in decreasing order of reactivity: RSiX₃, R₂ SiX₂, and R₃ SiX, where X is dialkyl amino (e.g., dimethylamino), halo (e.g., chloro), alkoxy, or other reactive groups. Some illustrative silanes for producing bonded silica, in order of decreasing reactivity, include n-octyldimethyl(dimethylamino)silane, n-octyldimethyl(trifluoroacetoxy)silane, n-octyldimethylchlorosilane, n-octyldimethylmethoxysilane, n-octyldimethylethoxysilane, and bis-(n-octyldimethylsiloxane). The monochlorosilane is the least expensive and most commonly used silane.

Other illustrative monochlorosilanes that may be used in producing bonded silica include, without limitation: Cl—Si(CH₃)₂—(CH₂)ₙ—X, where X is H, CN, fluorine, chlorine, bromine, iodine, phenyl, cyclohexyl, dimethylamine, or vinyl, and n is 1 to 30 (desirably 2 to 20, more desirably 3 to 18); Cl—Si(CH₃)₂—(CH₂)₈—H (n-octyldimethylsilyl); Cl—Si(CH(CH₃)₂)₂—(CH₂)ₙ—X, where X is H, CN, fluorine, chlorine, bromine, iodine, phenyl, cyclohexyl, dimethylamine, or vinyl; and Cl—Si(CH(Phenyl)₂)₂—(CH₂)ₙ—X where X is H, CN, fluorine, chlorine, bromine, iodine, phenyl, cyclohexyl, dimethylamine, or vinyl.

For chromatographic particles the surface derivatization is conducted according to standard methods, for example by reaction with n-octyldimethylchlorosilane in an organic solvent under reflux conditions. An organic solvent such as toluene is typically used for this reaction. An organic base such as pyridine or imidazole is added to the reaction mixture to accept hydrochloric acid produced from the reaction with silanol groups and thus drive the reaction towards the desired end product. The thus-obtained product is then washed with toluene, water and acetone and dried at 100° C. under reduced pressure for example for 16 hours.

The terms “functionalizing group” or “functional group” typically include organic functional groups that impart a certain chromatographic functionality to a chromatographic stationary phase, including, for example, octadecyl (C₁₈), phenyl, ligands with ion exchange groups, and the like. Such functionalizing groups are present in, for example, surface modifiers such as disclosed herein, which are attached to the base material, for example, via derivatization or coating and later crosslinking, imparting the chemical character of the surface modifier to the base material. In an illustrative embodiment, such surface modifiers have the formula Zₐ(R⁵)_{b}Si—R, where Z═Cl, Br, I, C₁-C₅ alkoxy, dialkylamino, such as dimethylamino, or trifluoromethanesulfonate; a and b are each an integer from 0 to 3 provided that a+b=3; R⁵ is a C₁-C₆ straight, cyclic or branched alkyl group, and R is a functionalizing group. R⁵ may be, but is not limited to, methyl, ethyl, propyl, isopropyl, butyl, t-butyl, sec-butyl, pentyl, isopentyl, hexyl or cyclohexyl.

The functionalizing group R may include alkyl, aryl, cyano, amino, diol, nitro, cation or anion exchange groups, or embedded polar functionalities. Examples of suitable R functionalizing groups include C₁-C₂₀ alkyl, such as octyl (C₈) and octadecyl (C₁₈); alkaryl, such as C₁-C₄-phenyl; cyanoalkyl groups, such as cyanopropyl; diol groups, such as propyldiol; amino groups, such as aminopropyl; and embedded polar functionalities, such as carbamate functionalities such as disclosed in U.S. Pat. No. 5,374,755. In some embodiments, for instance, the surface modifier may be a haloorganosilane, such as octyldimethylchlorosilane or octadecyldimethylchlorosilane.

In some embodiments, the chromatographic stationary phase may be endcapped. A chromatographic stationary phase is said to be “endcapped” when a small silylating agent, such as trimethylchlorosilane, is used to react residual silanol groups on a packing surface after initial silanization. It is most often used with reversed-phase packings and may reduce undesirable adsorption of basic or ionic compounds. For example, endcapping occurs when bonded silica is further reacted with a short-chain silane such as trimethylchlorosilane to endcap the remaining silanol groups. The goal of endcapping is to remove as many residual silanols as possible. In order of decreasing reactivity, illustrative agents that can be used as trimethylsilyl donors for end capping include, without limitation, trimethylsilylimidazole (TMSIM), bis-N,O-trimethylsilyltrifluoroacetamide (BSTFA), bis-N,O-trimethylsilylacetamide (BSA), trimethylsilyldimethylamine (TMSDMA), trimethylchlorosilane (TMS), and hexamethyldisilane (HMDS). Particularly suitable end-capping reagents include trimethylchlorosilane (TMS), trimethylchlorosilane (TMS) with pyridine, hexamethyldisilazane (HMDS), and trimethylsilylimidazole (TMSIM).

In some embodiments, the silanol groups may be reacted differently to form other covalently bonded functional groups in the manner described in U.S. Pat. No. 5,326,738 to Sandoval et al. Alternatively, the surface of the pores may be mechanically coated with graphite as described in C. Liang et al., Anal. Chem. 75 (2003) 4904-4912 or an organic polymer as described in M. Hanson et al, J. Chromatogr. 517 (1990) 269-284. All of these approaches are useful for making materials useful for several applications, but especially for BPLC.

### Packed Beds and Apparatus for Chromatography

Some embodiments of the present invention are directed to packed beds for liquid chromatography including a plurality of the microparticles described herein. In particular, the final microparticles, whether surface-modified or not, may be packed into highly homogeneous beds for applications such as BPLC. The reason for this is believed to be due to the extremely narrow particle size distribution and the higher particle density of the microparticles described herein, relative to traditional superficially porous particles. Columns of packed beds of these particles exhibit unusually high performance.

The high performance of these packed beds can be demonstrated by their reduced plate height values. For example, high quality commercial BPLC columns rarely show reduced plate heights as small as 2 for small molecules. By comparison, columns with packed beds of the inventive microparticles typically show reduced plate heights of less than 2, more specifically reduced plate heights of 1.5, and even more specifically reduced plate heights as low as 1.3 can be obtained when optimized systems are used. An example of optimized operating conditions may include the following: column dimensions of sufficient size to minimize band broadening caused by the instrumentation (e.g., 4.6 mm ID×50 mm long); mobile phase of low viscosity, such as 60% acetonitrile/40% water; mobile phase flowrate (or linear velocity) adjusted to a value that produces the lowest reduced plate height measurement (e.g., for a 4.6×50 mm column, approximately 1.8 milliliters per minute); operating temperature at ambient or higher; instrumentation that has been designed to cause minimal peak dispersion, including low-volume sample injection valve (e.g., Rheodyne Model 8125), low-volume detector cell (e.g., 2 microliters or less) and low-volume connecting tubing between the column and the injector and the column and detector cell (e.g., 0.005″ ID tubing of shortest lengths); small injection volume (e.g., 2 microliters or less); injected sample mass of the measured peak within the linear range of its adsorption isotherm (e.g., less than 100 nanograms of naphthalene); sample dissolved in a solvent weaker than the mobile phase (e.g., 50/50 acetonitrile/water if using 60/40 acetonitrile/water as mobile phase); measured peak has a long retention time (at least four times the retention time of a peak that has no interaction with the column, the so-called “unretained” peak); data handling software that samples the signal at least 20 times per second; and detector electronics that have response times faster than 0.05 seconds.

Reduced plate height is used as a measurement of the efficiency of a packed bed or packed column. Specifically, as mentioned above, the reduced plate, h, is the plate height, H, divided by the particle diameter. In general, the smaller the reduced plate height, h, the more efficient the packed bed or column. A reduced plate height of <2 is significantly smaller than those obtained with high quality commercial HPLC packed columns. This evidences that the microparticles described herein can be used to produce extremely efficient packed beds and columns, which are more efficient than packed beds of conventional particles.

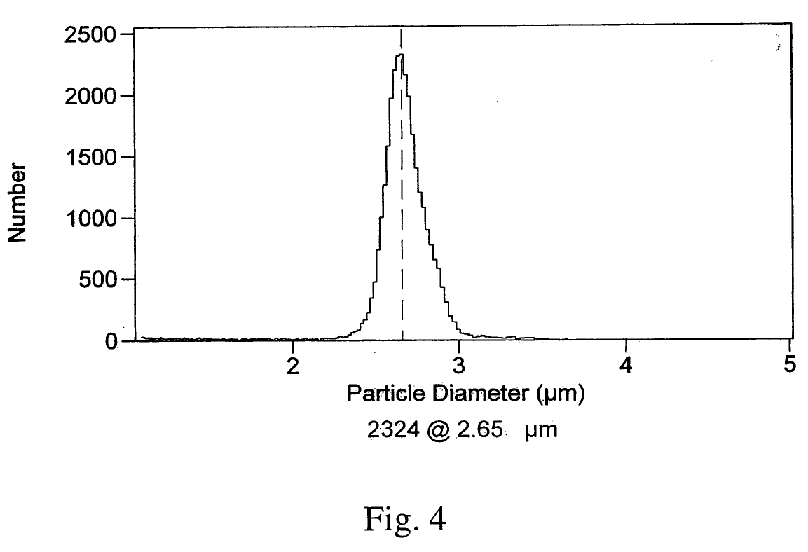

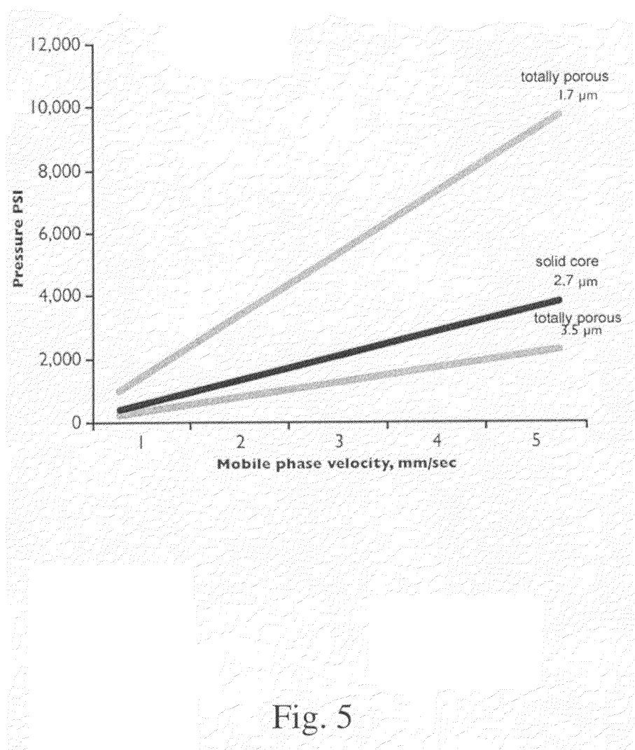

A strong factor for the highly efficient packed beds of the present invention is the extremely narrow particle size distribution with the inventive microparticles. These microparticles show a particle size distribution of less than ±15% (one sigma) of the volume average diameter, and often the particle size distribution may be less than ±10% (one sigma), and even ±5% (one sigma) of the volume average diameter. The extremely narrow particle size distribution of microparticles in accordance with some embodiments is shown in FIG. 4, which illustrates the distribution at 2.65 μm average particle diameter. In accordance therewith, columns packed with these microparticles are significantly more efficient than traditional commercial columns. For example, columns with 2.7 μm diameter microparticles exhibit comparative performance to conventional columns of 1.7 μm or 1.8 μm totally porous particles (referred to as sub-two-micron particles), but at much lower back pressures, as illustrated in FIG. 5. More specifically, as column packing particle size decreases, column back pressure rapidly increases. Columns packed with sub-two-micron particles, therefore, often experience high back pressures and require special equipment. As shown in FIG. 5, columns packed with 2.7 μm microparticles of the present invention only generate slightly higher back pressures than 3.5 μm totally porous particles and significantly lower back pressures than 1.7 μm totally porous particles.

Additionally, in some embodiments, the present invention is directed to an apparatus for liquid chromatography. The apparatus may be, for example, a HPLC column. The apparatus includes a region through which materials to be separated are passed and a packed bed, as described above. The packed bed is contained in the region through which the materials are passed. As above, the packed bed has a reduced plate height at the plate height minimum of less than about 2 under optimum operating conditions. An example of optimum operating conditions is set forth above.

### EXAMPLES

### Example 1

In the following example, particle size was measured using a Beckman Coulter instrument (Beckman Coulter Instruments, Fullerton, Calif.) as follows. For measurement, particles were suspended homogeneously in Isoton II (Beckman Coulter 8546719). A greater than 30,000 particle count may be run using a 20 μm aperture in the volume mode for each sample. Using the Coulter principle, volumes of particles are converted to diameter, where a particle diameter is the equivalent spherical diameter, which is the diameter of a sphere whose volume is equivalent to that of the particle.

Core particles of 2.06-μm diameter were prepared by the process of U.S. Pat. No. 4,775,520 to Unger et al. using 500 nm silica sol “seed” particles synthesized according to Stober et al., J. Colloid and Interface Sci. 26, 62-69 (1968). These particles were isolated by filtration, dried and heated to 1090° C. in a furnace for 24.5 hours to densify the particles. The densified particles then were boiled in 10% nitric acid for 16 hours to re-hydroxylate the surface, washed with deionized water and dried. These densified particles were measured as 1.8-μm diameter by the Coulter Counter.

A 10% by weight aqueous suspension of the silica core particles including 5 g of the surface-hydrolyzed SiO₂ particles of 1.8-μm diameter was brought to a pH of 2.3 with nitric acid. To theses cores was added 225 g of 0.5% by weight of aqueous solution of the polyelectrolyte, poly(diallyldimethylammonium) chloride (PDADMA) of “100-200 kD” molecular weight, according to the supplier (Sigma-Aldrich 409014). The polyelectrolyte and silica core suspension was mixed for 10 minutes, then centrifuged at 2,000 for 10 minutes (Sorvall model T6000 centrifuge) and the supernatant decanted. The cores then were re-suspended in deionized water, centrifuged at 2,000 rpm for 10 minutes, and the supernatant decanted. This washing with deionized water was repeated two additional times.

50 grams of an aqueous suspension of silica sol nanoparticles (9.88% SiO₂ by weight) of 8 nm diameter, adjusted to pH 3.5 with nitric acid, were added to the polyelectrolyte-modified cores and mixed with a stir bar for 15 minutes. The mixture of cores and nanoparticles was then centrifuged at 2,000 rpm for 10 minutes and the supernatant containing excess nanoparticles was decanted. The nanoparticles-coated cores were re-suspended in deionized water and the particle size was then measured by Coulter Counter. The process of coating the cores first with polyelectrolyte, then silica sol nanoparticles, was then repeated successively until the Coulter Counter measured the coated particles as 2.81 μm in diameter. The coated particles were then isolated by filtration, dried, placed in a quartz container and heated at 540° C. in a furnace overnight. The resulting silica particles were heated at 825° C. in air for 18 hours for strengthening. The surface of the sintered particles was then rehydroxylated by the dilute hydrofluoric acid method described in J. Kohler and J. J. Kirkland, J. Chromatogr., 385 (1987) 125-150. After liquid elutriation fractionation to eliminate a few aggregated particles resulting from the sintering process, these particles demonstrated an average particle size of 2.66±6% (one sigma) as measured by the Coulter Counter. The (nitrogen) surface area of these particles was 160 m²/g and the average pore size was 8.9 nm as measured by the Gemini V instrument (Micromeritics, Norcross, Ga.). Based on the diameter of the initial cores (1.7 μm) and the diameter of the final particles (2.7 μm), it was calculated that the thickness of the porous shell coating on the solid cores was 0.5 μm. Scanning electron microscopy of a cross-section of these particles (Micron, Wilmington, Del.) confirmed this thickness, as shown in FIG. 2.

Next, 10 g of the rehydroxylated particles were reacted with n-octyldimethyl(dimethylamino)silane (Geleste, Morrisville, Pa.) by refluxing with 12.5 grams of silane in 350 mL of toluene for 16 hours. The reacted particles then were washed exhaustively with toluene, tetrahydrofuran and acetonitrile by slurrying in these solvents, then dried in vacuum oven for 2 hours at 110° C. The C₈ functionalized particles exhibited 6.47% carbon by elemental analysis (Micro, Wilmington, Del.), representing a monofunctional stationary phase coating (bonding) of 3.49 μeq./g. The particles were then “endcapped” by refluxing with 3.4 g of (n,n-dimethylamino)trimethylsilane in 350 mL of toluene for 18 hours. The endcapped particles were washed in solvents as described above, isolated by filtration and dried in vacuum oven for 2 hours at 110° C. The final particles exhibited 6.54% carbon by elemental analysis, representing a monofunctional stationary phase coating (bonding) of 3.60 μeq./g.

A sample of the bonded and endcapped particles was loaded into a 50×4.6 column using the slurry packing method described in J. J. Kirkland and J. J. DeStefano, J. Chromatogr. A, 1126 (2006) 50-57. The final column was tested with a model 1100 liquid chromatograph (Agilent Technologies, Palo Alto, Calif.) using 70% acetonitrile/30% water as the mobile phase at 24° C. At a flow rate of 1.5 mL/min this column demonstrated 12,000 theoretical plates using naphthalene as the solute, representing a column performance with a reduced plate height h of 1.5.

### Example 2

A 10% by weight aqueous suspension of silica core particles including 5 g of SiO₂ particles of diameter 2.0 μm was brought to a pH of 2.3 with nitric acid. To these cores was added 200 grams of 0.5% by weight of aqueous solution of poly(diallyldimethylammonium) chloride (PDADMA). This solution was made by diluting 20% by weight aqueous solutions of polyelectrolyte (Sigma-Aldrich, 409014, 409022, and 409030—“Low”, “Medium”, and “High” weight average molecular weights of PDADMA were used, corresponding to M_{w} values of 100-200 kD, 200-350 kD, and 400-500 kD according to the manufacturer). The polyelectrolyte and silica core suspension was centrifuged at 2,000 rpms for 10 minutes (using a Sorvall T6000 model centrifuge) and the supernatant was decanted. The cores were resuspended in deionized water, centrifuged (about 2,000 rpms for 10 minutes) and the supernatant was decanted. This wash with deionized water was repeated one additional time. 50 grams of an aqueous suspension of silica nanoparticles (9.88% SiO₂ by weight) of diameter 8 nanometers (nm), adjusted to pH 3.5 with nitric acid, were added to the polyelectrolyte-coated cores and mixed for 10 minutes with a stir bar. The solution of cores and nanoparticles was then centrifuged (about 2,000 rpms for 10 minutes) and the supernatant containing excess nanoparticles in suspension was decanted. The nanoparticle-coated core material was resuspended in deionized water and the particle size of the nanoparticle-coated product was then measured by Coulter Counter. The number of layers of particles per coating was estimated from the increase in particle diameter.

Table 1 shows the number of layers of nanoparticles per coating (N) as a function of M_{w} of the polyelectrolyte.

TABLE 1

| M_{w} of Polyelectrolyte (kD) | N |
|---|---|
| 100–200 | 5 |
| 200–350 | 15 |
| 400–500 | 15 |

### Example 3

The procedure of Example 1 was followed to prepare microparticles having a particle diameter of 2.7 μm. A sample of the microparticles was loaded into a 50×4.6 mm liquid chromatographic column to form a packed column using the procedure described in Example 1. Packed liquid chromatographic columns of 50×4.6 mm of each of the following comparative particles were obtained: totally porous particles having a diameter of 5 μm (commercially available as “Ace” C₁₈); totally porous particles having a diameter of 3.5 μm (commercially available as “Zorbax” XDB-C₁₈); and totally porous particles having a diameter of 1.8 μm (commercially available as “Zorbax” XDB-C₁₈). The final columns were tested in a model 1100 liquid chromatograph (Agilent Technologies, Palo Alto, Calif.) using naphthalene as the solute and 60% acetonitrile/40% water as the mobile phase at 24° C.

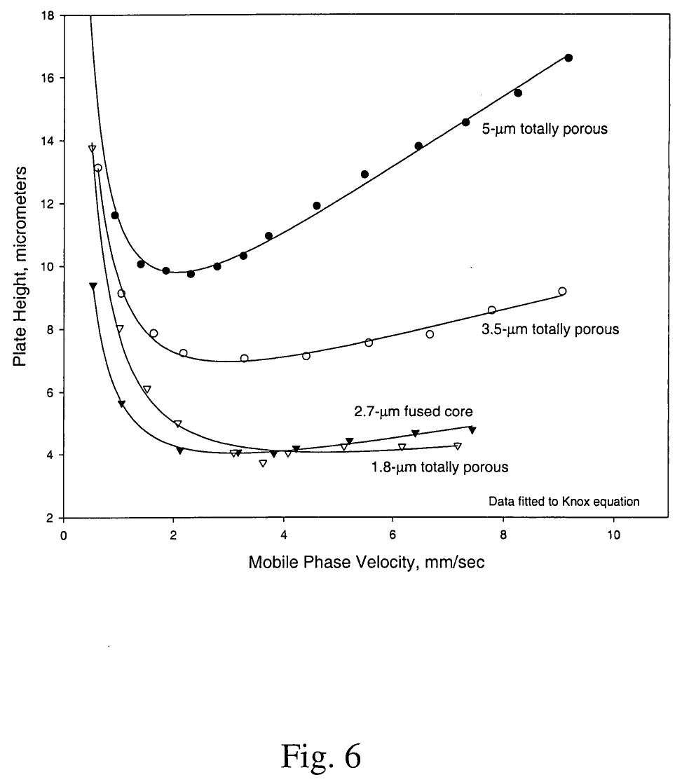

FIG. 6 demonstrates the performance of a packed column of the inventive microparticles in comparison to the packed columns of the three different types of totally porous particles, referred to above. In particular, FIG. 6 shows plate height versus mobile phase velocity plots for the particles tested. This type of plot is typically referred to as a Van Deemter plot, and is a well-recognized means of displaying performance of liquid chromatographic columns. This data shows that the inventive microparticles are superior to the 5 μm and 3.5 μm totally porous particles. The inventive microparticles permitted significantly lower plate heights, which indicates column efficiency, at much higher mobile phase velocities. Accordingly, separations can be performed faster and more efficiently.

### Example 4

The procedure of Example 1 was followed to prepare microparticles having a particle diameter of 2.7 μm. A sample of the microparticles was loaded into a 2.1×50 mm liquid chromatographic column to form a packed column using the procedure described in Example 1. The final column was tested in a model 1100 liquid chromatograph (Agilent Technologies, Palo Alto, Calif.) using a sample including uracil, phenol, 4-chloro-1-nitrobenzene and naphthalene as the solute arid 50% acetonitrile/50% water as the mobile phase, at 24° C., 260 bar column pressure and 1.0 mL/min flow rate.

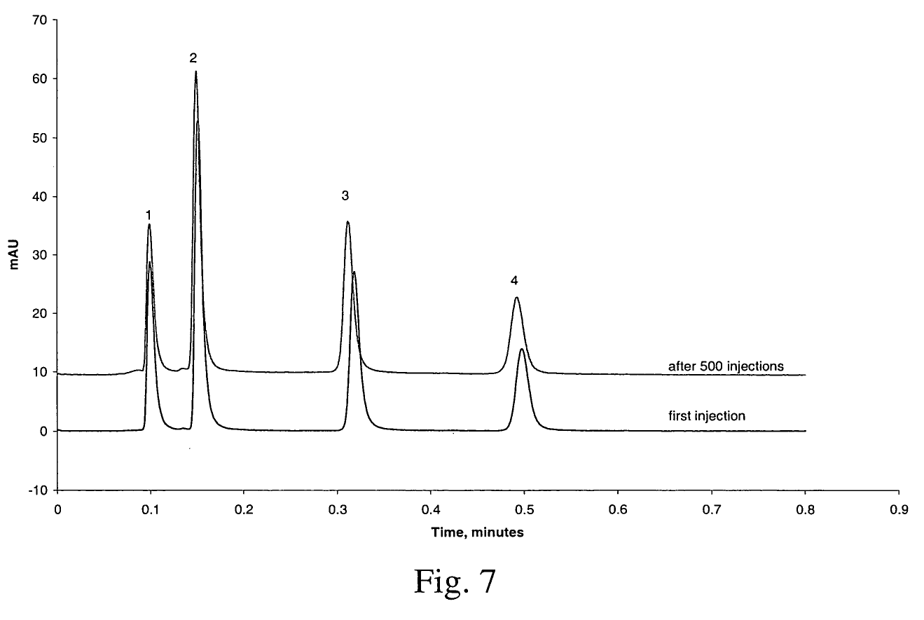

FIG. 7 demonstrates the stability of packed beds of the inventive microparticles. Specifically, FIG. 7 shows the chromatogram of the initial sample injection and the chromatogram after 71 hours of continuous flow (>40,000 column volumes) and 500 sample injections. As shown in FIG. 7, there was no evidence of any change to the packed bed after a substantial number of hours of continuous flow and sample injections.

What is claimed is:

1. A microparticle comprising:
a solid core; and
an outer porous shell surrounding said core, said shell comprising a plurality of colloidal inorganic nanoparticles,
wherein said microparticle has a diameter of about 1 μm to about 3.5 μm, a density of about 1.2 g/cc to about 1.9 g/cc and a surface area of about 50 m²/g to about 165 m²/g.

2. The microparticle of claim 1, wherein said microparticle is spherical.

3. The microparticle of claim 1, wherein said core is impervious.

4. The microparticle of claim 1, wherein said outer porous shell is irreversibly joined to said core.

5. A spherical silica microparticle comprising:
a solid silica core; and
an outer porous shell surrounding said core, said shell comprising a plurality of colloidal silica nanoparticles,
wherein said microparticle has a diameter of about 1 μm to about 3.5 μm, a density of about 1.2 g/cc to about 1.9 g/cc and a surface area of about 50 m²/g to about 165 m²/g.

6. The microparticle of claim 5, wherein said core is impervious.

7. The microparticle of claim 5, wherein said core has a diameter of about 1 μm to about 3 μm.

8. The microparticle of claim 5, wherein said shell is irreversibly joined to said core.

9. The microparticle of claim 5, wherein said shell has a thickness of about 0.1 μm to about 0.75 μm.

10. The microparticle of claim 5, wherein said shell comprises about 25% to about 90% by volume of said microparticle.

11. The microparticle of claim 5, wherein said colloidal silica nanoparticles comprise alike silica nanoparticles.

12. The microparticle of claim 5, wherein said colloidal silica nanoparticles are in a random open-packed structure.

13. The microparticle of claim 5, wherein said colloidal silica nanoparticles are solid.

14. The microparticle of claim 5, wherein said outer porous shell has a pore size of about 4 nm to about 175 nm.

15. The microparticle of claim 5, wherein said outer porous shell has a pore size distribution of about 40% to about 50% (one sigma) of the average pore size.

16. The microparticle of claim 15, wherein said microparticle has a porosity of about 55% to about 65% by volume of the outer porous shell.

17. A packed bed for liquid chromatography comprising:
a plurality of microparticles comprising a solid core and an outer porous shell surrounding said core, said shell comprising a plurality of colloidal inorganic nanoparticles,
wherein said microparticles have an average diameter of about 1 μm to about 3.5 μm, an average density of about 1.2 g/cc to about 1.9 g/cc and an average surface area of about 50 m²/g to about 165 m²/g, and
wherein said packed bed has a reduced plate height of less than about 2 at the plate height minimum under optimum operating conditions.

18. The packed bed of claim 17, wherein said packed bed has a reduced plate height of about 1.3 to about 2 at the plate height minimum under optimum operating conditions.

19. The packed bed of claim 17, wherein said microparticles have a particle size distribution of about ±10% (one sigma) or less of the volume average diameter.

20. The packed bed of claim 17, wherein said microparticles have a particle size distribution of about ±5% (one sigma) of the volume average diameter.

21. The packed bed of claim 17, wherein said solid core comprises a solid silica core.

22. The packed bed of claim 17, wherein said colloidal inorganic nanoparticles comprise solid silica nanoparticles.

23. An apparatus for liquid chromatographic separations comprising:
a region through which materials to be separated are passed; and
a packed bed comprising a plurality of microparticles contained in said region, said microparticles comprising a solid core and an outer porous shell surrounding said core, said shell comprising a plurality of colloidal inorganic nanoparticles,
wherein said microparticles have an average diameter of about 1 μm to about 3.5 μm, an average density of about 1.2 g/cc to about 1.9 g/cc and an average surface area of about 50 m²/g to about 165 m²/g, and
wherein said packed bed has a reduced plate height of less than about 2 at the plate height minimum under optimum operating conditions.

24. The apparatus of claim 23, wherein said apparatus comprises a high performance liquid chromatography column.
